(19) United States
(12) Patent Application Publication
(10) Pub. No.: US 2005/0166536 A1
(43) Pub. Date: Aug. 4, 2005

(54) Method and apparatus for creating creased facing material for insulation product applications

(76) Inventors: Michael J. Lembo, Souderton, PA (US); Thomas Cuthbertson, Royersford, PA (US)

Correspondence Address: DUANE MORRIS, LLP;IP DEPARTMENT, ONE LIBERTY PLACE, PHILADELPHIA, PA, 19103-7396, US

(21) Appl. No.: 11/093,379

(22) Filed: Mar. 30, 2005

Related U.S. Application Data
(63) Continuation-in-part of application No. 10/793,496, filed on Mar. 4, 2004.
(63) Continuation-in-part of application No. 10/690,295, filed on Oct. 21, 2003.

(51) Int. Cl. B31F 1/00

(52) U.S. Cl. 52/745.19

(57) ABSTRACT

An apparatus is disclosed for imparting a crease in a facing layer that is bonded to an insulation mat having first and second major surfaces and a pair of side portions. The apparatus can comprise a pair of opposing creasing bars or rollers between which the facing layer is fed in a machine direction. The bars or rollers can impinge upon the paper to create a crease oriented parallel to the machine direction of the facing layer. The insulation mat may be separable in the machine direction, and the crease can be imparted so that the separable portions of the insulation mat substantially align with the crease in the facing layer to allow the facing and insulation to be separated together. The creasing bars or rollers can be adjustable and controlled manually. Control may also be automated. A method of using the apparatus is also disclosed.

### CROSS-REFERENCE TO RELATED APPLICATIONS

This application is a continuation-in-part of copending, commonly assigned patent applications U.S. patent application Ser. No. 10/793,496, entitled “Insulation Product Having Directional Facing Layer Thereon and Method of Making the Same,” filed Mar. 4, 2004, and is also a continuation-in-part of copending U.S. patent application Ser. No. 10/690,295, entitled “Separable Fibrous Insulation”, filed Oct. 21, 2003; the entirety of which applications are expressly incorporated by reference herein. This application is also related to the following copending, commonly assigned patent applications: U.S. patent application Ser. No. 10/851,509, entitled “Segmented Band Joist Batts and Method of Manufacture”, filed May 21, 2004, which claims priority to U.S. Provisional Patent Application No. 60/540,764 filed Jan. 30, 2004; U.S. patent application Ser. No. 10/851,877, entitled “Kit of Parts for Band Joist Insulation and Method of Manufacture”, filed May 21, 2004, which claims priority to U.S. Provisional Patent Application No. 60/540,939 filed Jan. 30, 2004; and U.S. Utility patent application Ser. No. 10/779,18 1, entitled “Method and Apparatus for Adhering Together Lanes of Compressible Products”, filed Feb. 11, 2004; the entirety of which applications are expressly incorporated by reference herein.

### FIELD OF THE INVENTION

The present invention relates to insulation products and methods of making the same, and more particularly to insulation products having facing layers thereon and methods of making the same.

### BACKGROUND OF THE INVENTION

When insulating structures, typically residential homes, the installer often encounters framing members that are spaced apart at nonstandard distances less than the standard spacing relationship. When insulating these elongated cavities of various nonstandard widths, less than a standard width, it has been the practice to take an insulation batt preformed to fit the standard cavity width and reduce the width of the insulation batt by cutting off and removing a strip of insulation material from one or both longitudinal edges of the insulation batt. This method of trimming the insulation batts at the job site by cutting the batts to fit between the more closely spaced support members is time consuming, raises a significant risk or safety issue and relies heavily on the worker's skill to accurately trim the batt or panel.

U.S. Pat. No. 6,551,677 to Weinstein et al., entitled “Facing for Pre-Cut Fibrous Insulation Blankets”, issued Apr. 22, 2003, (Weinstein I) the entirety of which is hereby incorporated by reference herein, describes an elongated insulation blanket that has a series of cuts extending between the major surfaces of the blankets with successive cuts being separated by a series of separable connectors located intermediate the major surfaces of the blanket. Each series of separable connectors holds together adjacent sections of the blanket for handling, but are separable by hand so that the blanket can be handled as a unit for insulating a cavity having a predetermined width or separated by hand into two or more sections at one or more of the series of the separable connectors for insulating a cavity having a lesser, nonstandard width. The blanket has a facing bonded thereto by a bonding agent, having one or more perforated lines in the facing that permit the facing to be separated by hand at each series of cuts and separable connectors.

Although Weinstein I provides a modular mat that can be separated into insulation mats of smaller widths, the use of a perforated facing layer raises several issues. For example, additional steps must be employed to form perforations in the facing layer. Further, it is believed that the perforations may provide breaches in the vapor barrier provided by the facing layer if the bonding agent does not fully or adequately fill the perforations. These localized vapor barrier failures compromise the effectiveness of the insulation mat when the mat is used with, for example, support members spaced at standard widths, i.e., when the separable segments of the mat are not removed.

U.S. Pat. No. 6,468,615 to Weinstein et al., entitled “Pre-Cut Fibrous Insulation Blanket”, issued Oct. 22, 2002 (Weinstein II), the entirety of which is hereby incorporated by reference herein, also describes insulation mats having permeable sheets on a first and/or second major surface of that mat, where the permeable sheets are separable by hand due to the low tear strength of the sheets. The sheets are described as having the tear strength about equal to the tear strength or tensile strength of facial or bathroom tissue. These permeable sheets are not vapor barrier facing layers, which are also shown coupled to the mats.

Therefore, there is a need for an insulation product, and method of making the same, that can be formed into sections having nonstandard widths, but without significant field work and without compromising the vapor barrier formed on the insulation product.

### SUMMARY OF THE INVENTION

An apparatus is disclosed for imparting a crease in a layer of insulation facing material. The apparatus can comprise first and second facing layer feed elements configured to convey a layer of insulation facing material in a machine direction. A creasing assembly can be disposed between the first and second feed elements, the creasing assembly comprising first and second creasing surfaces for receiving a layer of facing material therebetween. The creasing surfaces can be configured to engage opposite surfaces of the facing material. When the feed elements operate to convey the facing material in the machine direction, the creasing surfaces are engageable with the opposite surfaces of the facing layer to impart a crease in the facing layer sufficient to allow the layer to be preferentially separated by hand along the crease.

An apparatus for creasing a layer of insulation facing material is disclosed, comprising first and second feed elements configured to convey a layer of insulation facing material in a machine direction and along a first plane. A facing layer creasing assembly can be disposed between the first and second feed elements, the creasing assembly comprising first and second opposable creasing elements, each having a creasing surface, the first creasing surface positioned to engage a first surface of the facing layer and the second creasing surface positioned to engage an opposite second surface of the facing layer. The creasing elements further can have a creasing position in which the first creasing surface is located a first distance above the first plane of the facing layer, and the second creasing surface is located a second distance below the first plane layer, so that when the first and second feed elements convey the facing material in the machine direction, a portion of the facing layer travels along a Z-shaped path as it travels between the first and second creasing surfaces. Thusly arranged, the contact between the creasing surfaces and the facing layer can impart a crease in the facing layer sufficient to allow the layer to be preferentially separated by hand along the crease.

A method of manufacturing an insulation product is also disclosed, comprising providing an insulation mat having first and second major surfaces and a pair of side portions; providing a facing layer; providing a creasing apparatus having first and second opposing creasing surfaces; disposing the facing layer between the creasing surfaces; and moving the facing layer between the creasing surfaces in a machine direction; wherein the step of moving the facing layer causes the creasing surfaces to impart a fault plane in the facing layer along which the facing layer can be separated by hand.

### BRIEF DESCRIPTION OF THE DRAWINGS

The accompanying drawings illustrate preferred embodiments of the invention, as well as other information pertinent to the disclosure, in which:

FIG. 1 is an end elevation view of an insulation product of this invention;

FIG. 1A is an end elevation view of the insulation product of FIG. 1 shown partially separated along its length;

FIG. 2 is a bottom plan view of the insulation product of FIG. 1;

FIG. 2A is a bottom plan view of the insulation product of FIG. 1 shown partially separated along its length;

FIG. 3 is a schematic view illustrating a process of adhering a facing layer to an insulation mat;

FIG. 4 is a top plan view of a faced insulation product having a perforated insulation mat;

FIG. 5 is an end elevation view of an insulation product having a creased facing layer;

FIG. 6 is a perspective view of an apparatus for creating the creased facing layer of FIG. 5;

FIGS. 6A, B and C are side, top and end views, respectively, of a creasing bar portion of the apparatus of FIG. 6;

FIG. 7 is a schematic view illustrating a process of creasing and adhering a facing layer to an insulation mat;

FIGS. 8A, B and side and end views, respectively, of an alternative apparatus for creating the creased facing layer of FIG. 5;

FIG. 8C is a cross sectional view of another alternative embodiment of the apparatus of FIG. 5;

FIG. 9 is a cross sectional view of a further alternative embodiment of the apparatus of FIG. 5;

FIGS. 10A-C are cross section views of alternative embodiments of the apparatus of FIGS. 8A, B;

FIG. 11 is a cross section view of a further alternative embodiment of the apparatus of FIGS. 8A, B;

FIG. 12 is a top view of an apparatus for creating multiple creases in a single layer of facing material;

FIGS. 13A and B are cross section and side views, respectively, of an additional alternative embodiment of the apparatus of FIGS. 8A, B.

### DETAILED DESCRIPTION

As used herein, the following terms are defined:

“Mat” means a fibrous material consisting of randomly oriented filaments, short fibers (with or without a carrier fabric), or swirled filaments held together with a binder, and are available in blankets of various thicknesses, widths, weights, and lengths. As used herein, “Insulation Mat” includes insulation boards, such as duct boards, insulation batts and acoustic insulation;

“Machine Direction” as used herein with respect to a layer means the direction in which the greater number of the fibers of a sheet of paper tend to be oriented as a result of the forward motion of the wire of the papermaking machine. The paper so produced is stronger in the machine direction, and also experiences less dimensional variation in the machine direction due to changes in humidity;

“Cross Machine Direction” with respect to a layer means the direction at right angles to the machine direction;

“Tensile Strength” means the load or force required to break a specimen;

“Tear Strength” means the force required to tear a layer at a precut edge, to a specific length, and measured in milli-Newton. This property is typically importance for printing, writing and wrapping papers.

Provided herein are methods for manufacturing faced insulation products and the faced insulation products made thereby. Insulation materials generally span the range from light weight, flexible and resiliently compressible foams and nonwoven fiber webs to rigid or semi-rigid boards. Generally, these insulating materials have densities in the range of about 0.4-7 lb/ft³ (6.4-112 kg/m³). Foam and nonwoven fiber web materials are usually provided in continuous sheeting that is sometimes cut to preselected lengths, thus forming batts. These articles are usually characterized as “low density,” having a density in the range of about 0.5-6 lb/ft³ (8-96 kg/m³), and preferably about 0.4-4 lb/ft³ (6.4-64 kg/M³), and more preferably 0.4 to 1.5 lb/ft³ (6.4-24 kg/M³). The thickness of insulation blanket or mat is generally proportional to the insulated effectiveness or “R-value” of the insulation. These low density insulation mats typically have a thickness between about 3.5-12 inches.

In contrast, rigid to semi-rigid insulation boards (“high density” insulation) tend to have densities in the higher portion of the range, at about 2-7 lb/ft³ (32-112 kg/m³), and preferably at about 4-7 lb/ft³ (64-112 kg/M³). These boards customarily are produced as sheets typically having a thickness in the range of about 0.25-4 inches, and more preferably about 0.5-4 inches, and about 2-4 feet wide by about 4-12 feet in length.

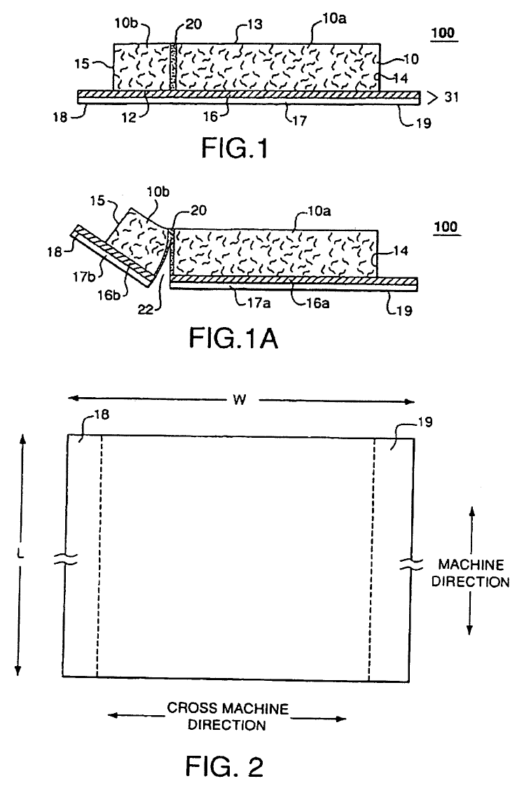

With reference to the Figures, and more particularly to FIG. 1 thereof, insulation product 100 is shown. Insulation product 100 includes insulation sheet 10, which may comprise a high or low density insulation mat or board, as described above, formed from organic fibers such as polymeric fibers or inorganic fibers such as rotary glass fibers, textile glass fibers, resinous fibers, stonewool (also known as rockwool) or a combination thereof. Mineral fibers, such as rotary glass fibers, are preferred for low density insulation batts. Insulation sheet 10 includes first and second major surfaces 12, 13 and longitudinal side portions 14, 15. In some embodiments, a vapor retarder facing layer 17, which may be a cellulosic paper, typically formed from kraft paper, coated with a bituminous adhesive material, such as asphalt, polymeric resin, or polymeric film, such as LDPE (low density polyethylene), or a combination of these materials, is provided on one major surface 12 of the insulation sheet 10. In one preferred embodiment, the facing layer 17 and bituminous layer 16 together form bitumen-coated kraft paper 31. The coating is preferably applied in a sufficient amount so as to provide an effective barrier or retarder for water vapor, for example, so as to reduce the water vapor permeability of the kraft paper to no more than about one perm when tested by ASTM E96 Method A test procedure. Optionally, the facing layer 17 can be secured to the bottom of major surface 12 of the insulation sheet 10 by an adhesive, such as a hot-melt adhesive. Additional details of facing layer 17 are provided below.

Insulation product 100 may include a pair of optional side tabs 18 and 19 that can be fastened to wooden or metal studs, for example. Various known configurations for side tabs or flaps 18 and 19 are known. Alternatively, there can be no tabs on.the kraft facing. The facing layer 17 can be water vapor impermeable or permeable, depending on its makeup, degree of perforation and intended use.

In an exemplary embodiment, insulation sheet 10 is a low density matt or batt formed from glass fibers bound together with a heat cured binder, such as known resinous phenolic materials, like phenolformaldehyde resins or phenol urea formaldehyde (PUFA). Melamine formaldehyde, acrylic, polyester, urethane and furan binder may also be utilized in some embodiments. The insulation is typically compressed after manufacture and packaged, so as to minimize the volume of the product during storage and shipping and to make handling and installation of the insulation product easier. After the packaging is removed, the batt insulation product 100 tends to quickly “fluff up” to its prescribed thickness for insulation.

Referring again to FIG. 1, insulation mat 10 includes first separable segment 10a and second separable segment 10b separably connected to each other in one embodiment with an adhesive 20, such as a hot melt adhesive, such hot melt adhesives available from Henkel Adhesives as product #80-8273. Although mat 10 is illustrated as including two separable segments 10a, 10b, this is for illustrative purposes only and mat 10 can include any number of separable longitudinal segments. Mat 10 may be sized to fit between support members spaced at standard widths, while segments 10a, 10b can be sized to accommodate anticipated, nonstandard or standard spacings. In one embodiment of the mat 10 of FIG. 1, mat 10 has a total width between about 11-24″. In this embodiment (assuming a product of roughly 15-16″ in width), section 10a has a width between about 9-13″ and section 10b has a width between about 2-7″.

Although FIG. 1. illustrates adhesive layer coupling segments 10a and 10b together along substantially the entire thickness and length of the insulation mat 10, this is not a requirement, and a variety of other adhesive configurations can be used. For example, the adhesive layer need not extend the entire length of the interior surfaces of the segments in plane 22. Rather, the adhesive layer can be intermittently applied on the surfaces along the length of segments 10a and/or 10b. In one embodiment, the adhesive layer 20 may comprise one ore more adhesive strips located between the first and second major surfaces 12, 13 and extending along the inner surfaces segments 10a and/or 10b. In one embodiment, mat 10 is approximately 15″ wide and has a thickness of approximately 3.5″. An adhesive bond running substantially the entire length of the mat 10 and having a height of about 1″ (i.e. the bond will span about 1″ of the total 3.5″ thickness of the mat) should provide sufficient adhesion between separable segments 10a and 10b. In one embodiment, a first longitudinal strip of adhesive running substantially the entire length of the mat 10 and having a height of about 0.5″ is applied approximately 1″ above the first major surface 12 and along an interior surface of segment 10a and/or 10b and a second longitudinal strip of adhesive having a height of about 0.5″ is applied approximately 1″ below the second major surface 13 and along an interior surface of segment 10a and/or 10b. In a second embodiment, mat 10 is approximately 15″ wide and has a thickness of approximately 6.25″. In this embodiment, an adhesive bond having a height of about 2″ should provide sufficient adhesion between separable segments 10a and 10b. In one embodiment, a first 0.5″ high longitudinal strip of adhesive is applied approximately 1″ above the first major surface; as second 0.5″ high longitudinal strip of adhesive is applied approximately 0.5″ above the first longitudinal strip; a third 0.5″ longitudinal strip of adhesive is applied approximately 1.25″ above the second longitudinal strip; and, a fourth 0.5″ longitudinal strip of adhesive is applied approximately 0.5″ above the third longitudinal strip and approximately 1″ from the second major surface 13.

Additionally, adhesive may be applied between the separable segments 10a, 10b using one or more spray nozzles, as described in co-pending U.S. patent application Ser. No. 10/779,181, entitled “Method and Apparatus for Adhering Together Lanes of Compressible Products”, filed Feb. 11, 2004, the entirety of which application is incorporated herein by reference. The nozzles may be adjustable, or rotatable, to allow the adhesive material to be applied to the inside walls of the separable segments 10a, b at different heights. The nozzles may be operated manually or may be controlled by a programmable controller. The controller may signal the nozzles to turn off and on and/or may control the placement of the adhesive material by adjusting or rotating the nozzles. The nozzles may apply the adhesive material in a straight line or in a pattern such as a figure eight, for example.

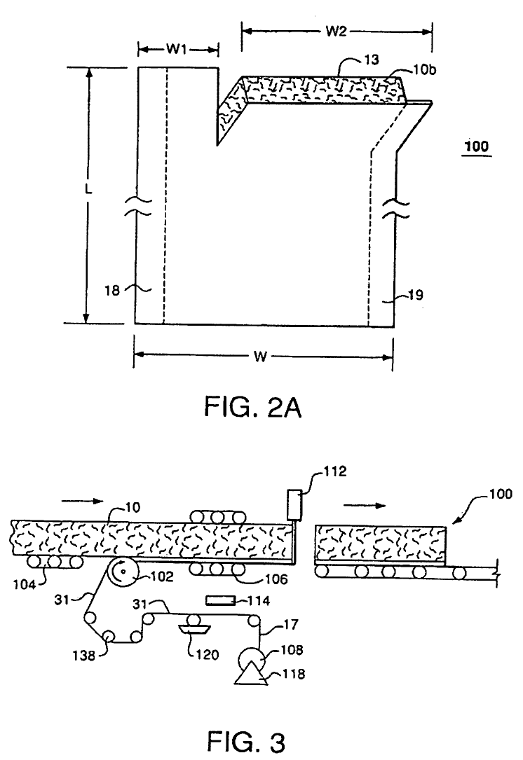

FIG. 2 is a bottom plan view of insulation product 100. The dashed lines illustrate the position of tabs 18 and 19, and do not illustrate perforations. Insulation product 100 has a defined width W and length L, which may vary depending on whether insulation product 100 is provided in roll or batt form. In an exemplary embodiment of insulation product 100, facing layer 17 comprises a cellulosic fiber containing material, such as a cellulosic paper, preferably a directional kraft paper having fibers oriented in substantially the machine direction, as opposed to the cross machine direction. Alternatively, a polymeric film, woven knit or nonwoven with anisotropic mechanical properties can be used. Mixtures of polymeric, cellulosic and inorganic fibers can be used. These alternative facing layers may be coupled to the mat with, for example, a hot melt adhesive.

Facing layer 17 is shown coextensive with major surface 12 of insulation mat 10 and is preferably not perforated, at least in the machine direction, thereby providing a continuous vapor barrier or retarder for insulation mat 10 in conjunction with coating 16. The machine direction fiber orientation imparts greater tensile strength in facing layer 17 in the machine direction compared to the cross machine direction and, it is believed, improves the tear strength ratio of cross machine direction tear strength to machine direction tear strength. Tear strength, while being relatively inversely proportional to tensile strength, to some extent is also a factor of paper thickness and paper weight.

Conventional non-directional kraft paper, such as 42#/3000 ft² semi-extensible kraft paper manufactured by Canfor Co. of Vancouver, British Columbia or International Paper Co. of Stamford, Connecticut, which, by definition, does have fibers oriented in the machine direction but not to the extent of the substantial orientation of the fibers in the directional kraft paper, does not exhibit noticeable “anisotropy” in other physical characteristics, such as the relative difference in tear strength between the cross machine direction and machine direction. For example, the 42#/3000 ft² product exhibits a machine direction tensile strength to cross machine direction tensile strength ratio of about 2.5:1 but a machine direction to cross machine direction tear strength ratio of only about 5:4 as discerned from the product specification/vendor sample property sheets. This relatively unitary tear strength ratio does not allow for the easy creation of clean, straight tears in the paper in the machine direction without the aid of a cutting tool. In other words, the paper exhibits unintended and significant propagation of the tear in the cross direction. As will be apparent to one of ordinary skill in the art, this will also be true for greater or lesser-weight non-directional kraft paper.

Although it is preferred that the fiber orientation is such that the facing layer has a ratio of machine direction tensile strength to cross machine direction tensile strength which permits the facing layer to be separated by hand along a substantially straight line selected in the machine direction, and thus the tear strength of the layer 17 is sufficiently higher in the cross machine direction than the machine direction, the difference should not be so great such that the separable segments are prone to unplanned separation, such as during shipping or packaging or during deployment of product 100 as a unitary product rather than separable segments. In one embodiment, the ratio of the machine direction tensile strength to cross machine direction tensile strength in facing layer 17 is at least about 4:1, and more preferably at least about 6:1, and still more preferably at least about 8:1. In one embodiment, the ratio is between about 4:1 to 20:1, and more preferably, between about 6:1 to 15:1, and more preferably between about 8:1 to 11:1.

The preferred facing layer has been described in terms of its fibers and fiber orientation being selected to provide a specified ratio of machine direction tensile strength to cross machine direction tensile strength sufficient to provide a cross machine direction tear strength to machine direction tear strength, such as measured by the Elmendorf Tear test. The machine direction and cross direction tear strengths are not believed to be linearly related to tensile strength, and do depend at least in part on paper weight and thickness.

In any event, the ratio of the machine direction tensile strength to cross machine direction tensile strength is preferably selected such that facing layer 17 can be torn or otherwise easily separated along plane 22 (FIG. 1A) in the machine direction (parallel to longitudinal edges 14, 15) that separates the separable segments of mat 10 without the use of perforations in layer 17 and without the propagation of the tear significantly in the cross machine direction. The absence of perforations in layer 17 prevents possible breaches of the vapor barrier in layer 31 at the perforations, particularly when the insulation product is used between support members spaced at standard distances, i.e., when the separable segments are not removed from the mat 10. Still further, the layer 17 can be torn in the machine direction at any location along the width W of mat 10. This feature allows the manufacturer to locate the connection between the separable segments of insulation mat 10 (shown at adhesive connection 20 of FIG. 1) at any point along the width of mat 10 without changing the configuration of layer 17. With prior art mats, the perforation location in the facing layer would have to be adjusted to align with the connection of the separable segments if they were resized. This feature, therefore, helps to simplify the manufacturing process and can reduce or eliminate the need to store facing layers having variably located longitudinal perforations.

FIG. 1A illustrates separable segments 10a and 10b and facing layer 31 partially separated starting from first major surface 12 towards second major surface 13. Alternatively, the segments can be separated starting from second major surface 13 towards first major surface 12 as shown in the partial separation illustrated by FIG. 2A. The connection between separable segments and the tear strength/tensile strength of the facing layer 17 in the machine direction are preferably selected to allow for a field separation, such as by tearing by hand without the aid of a tool, such as a cutting tool, although this option is not precluded. In one embodiment, prior to tearing facing layer 17 in the field, layer 17 is creased at a selected location in the machine direction to further aid in creating a straight, clean tear. For example, segments 10a and 10b can be separated starting from second major surface 13 towards first major surface 12 and towards facing layer 31. Once segments 10a and 10b are separated, facing layer 31 is then creased at the separation between the separable segments and then torn in the machine direction in a clean, longitudinal tear to form two separate faced longitudinal mat segments. Alternatively, the layer 17 may be pre-creased in the machine direction at the desired tear location, i.e., creased prior to gluing or otherwise bonding the layer 17 to the major surface of the mat. This embodiment 100B is illustrated in FIG. 5, showing longitudinal crease 21 in the facing layer 17, which is coupled to the insulation mat by adhesive layer 16.

The increased machine direction strength also provides increased resistance against tearing in tabs 18 and 19 when tabs 18 and 19 are secured to framing members, such as by staples or other fastening means. Although tabs 18 and 19 may be folded one or more times to increase the thickness of tabs 18 and 19, thereby increasing their tear strength, the improved tear resistance may permit tabs 18 and 19 to comprise a single layer of paper 17, i.e., tabs 18 and 19 may be deployed as unfolded tabs. This, in turn, reduces the original width of the layer 17 by, for example, about 10% (assuming 2 inches are removed from a 20 inch wide facing layer affixed to mat 10), thereby reducing the cost of the paper, the cost of storing the paper and the cost of insulation product 100. Still further, because of the increased cross-direction tear strength of the layer 17, it may be possible to use lighter weight paper, thereby further reducing the cost of the product 100 as well as its weight.

In one embodiment, layer 17 comprises a 15-60#/2880 ft² directional kraft paper, more preferably a 27-42#/2880 ft² directional kraft paper, and most preferably a 27-37#/2880 ft² directional kraft paper, such as is available from Lydall, Inc. of Manchester, Connecticut. Examples of directional kraft paper available from Lydall, Inc. include the following (note: product information obtained from Lydall):

| | | English | | |
|---|---|---|---|---|
| Product | Property | Units | Metric Units | Test Method |
| 18-1/2# | Basis Weight | 18 (lb/2880 ft²) | 30.5 (g/m²) | TAPPI T-410 |
| Manning ® 456 | | | | |
| | Thickness | 3 (mil) | 0.076 (mm) | TAPPI T-411 |
| | Tensile: | | | |
| | Machine Direction | 26 (lb/in) | 11.6 (Kg/25 mm) | Manning Test |
| | Cross machine | 2.9 (lb/in) | 1.3 (Kg/25 mm) | #020 |
| | direction | | | |
| | Tear (Machine | 55 (g) | 55 (g) | TAPPI T-414 |
| | Direction) | | | |
| 27-1/2# | Basis Weight | 26.5 (lb/2880 ft²) | 44.2 (g/m²) | TAPPI T-410 |
| Manning ® 556 | | | | |
| | Thickness | 4.1 (mil) | 0.104 (mm) | TAPPI T-411 |
| | Tensile: | | | |
| | Machine Direction | 36 (lb/in) | 16.4 (Kg/25 mm) | Manning Test |
| | Cross machine | 3.5 (lb/in) | 1.6 (Kg/25 mm) | #020 |
| | direction | | | |
| | Tear (Machine | 70 (g) | 70 (g) | TAPPI T-414 |
| | Direction) | | | |
| 35# Manning ® | Basis Weight | 34.0 (lb/2880 ft²) | 57.7 (g/m²) | TAPPI T-410 |
| 532 | | | | |
| | Thickness | 4.9 (mil) | 0.124 (mm) | TAPPI T-411 |
| | Tensile: | | | |
| | Machine Direction | 34 (lb/in) | 15.2 (Kg/25 mm) | Manning Test |
| | Cross machine | 5.3 (lb/in) | 2.4 (Kg/25 mm) | #020 |
| | direction | | | |
| | Tear (Machine | 105 (g) | 105 (g) | TAPPI T-414 |
| | Direction) | | | |

The 18-1/2# Manning® 456 paper has a machine direction to cross machine direction tensile strength ratio of about 8.97:1. The ratios for the 27-1/2# Manning® 556 and 35# Manning® 532 products are about 10.29:1 and 6.42:1, respectively.

Various trials were run to face glass fiber insulation mats with asphalt coated traditional non-directional kraft paper and directional kraft paper. The line speed was run at 120 ft/min using 15″×93″ folded kraft paper faced batts split into two 7.5″ wide pieces connected by an approximately ⅛″ high strip of uncut mat along the bottom of the mat. In the first trial, standard, non-directional 42#/3000 ft² semi-extensible kraft paper available from Canfor Co. was applied to the insulation batts with a bituminous layer, with a crease in the paper applied by two creasing bars in the production line. The facing layer did not tear well along the crease located above the connection between the two separable batt segments. The separation began at the crease point, but very quickly (within the first few inches of the edge of the paper) began a cross machine direction propagation rather than following the crease.

In a second production run, the traditional non-directional kraft paper was replaced by an uncreased 37#/2880 ft² Manning® directional kraft paper available from Lydall, Inc. It was observed that the faced insulation batt split better (compared to the non-directional kraft paper) but exhibited some problems following the connection between the two separable segments. In a third production run, the 37#/2880 ft² directional kraft paper was creased prior to bonding to the insulation batt. A significant improvement was observed in the product; a hand tear or rip of the facing layer followed the crease very well until about the last 3″ of the product.

In a fourth production run, 27#/2880 ft² Manning® directional uncreased kraft paper was bonded to the insulation batt. It was observed that the 27# paper tore more easily than the 37# sample, but the paper did not follow the split between the batt segments as well as the 37# creased sample. In a fifth production run, the 27# paper was creased prior to bonding to the insulation batt. It was observed that the paper split well along the crease but had a tendency to shatter occasionally across its width, i.e., in the cross machine direction. This result may be due to the reduction in paper weight from the 37# to 27# kraft paper.

In a final production run, 0.00177″ Manning® uncreased directional kraft paper was bonded to the fiberglass batt. The paper has a described thickness of about 0.00177″ and a paper weight of about 18.1#/2880 ft². The asphalt layer was very easy to see through the kraft paper, and it proved difficult to keep wrinkles out of the paper as it was applied. The product separated very easily but tended to separate at one of the natural wrinkles in the kraft. The trial with respect to this facing layer was then discontinued.

The following table indicates the product data available from Lydall on the tested directional kraft papers:

| | | English | | |
|---|---|---|---|---|
| Product | Property | Units | Metric Units | Test Method |
| 37# Manning ® | Basis Weight | 37.0 (lb/2880 ft²) | 62.8 (g/m²) | TAPPI T-410 |
| kraft | | | | |
| | Thickness | 3.6 (mil) | 0.09 (mm) | TAPPI T-411 |
| | Tensile: | | | |
| | Machine Direction | 69 (lb/in) | 30.8 (Kg/25 mm) | TAPPI T-494 |
| | Cross machine | unavailable | unavailable | |
| | direction | (lb/in) | (Kg/25 mm) | |
| | Tear (Machine | 58 (g) | 58 (g) | TAPPI T-414 |
| | Direction) | | | |
| 27# Manning ® | Basis Weight | 27.0 (lb/2880 ft²) | 45 (g/m²) | TAPPI T-410 |
| 254 Insuldur | | | | |
| | Thickness | 2.74 (mil) | 0.070 (mm) | ASTM D-202A |
| | Tensile: | | | |
| | Machine Direction | 52 (lb/in) | 23.2 (Kg/25 mm) | TAPPI T-494 |
| | Cross machine | unavailable | unavailable | |
| | direction | (lb/in) | (Kg/25 mm) | |
| | Tear (Machine | 33 (g) | 33 (g) | TAPPI T-414 |
| | Direction) | | | |
| .00177″ | Basis Weight | 18.1 (lb/2880 ft²) | 30.7 (g/m²) | TAPPI T-410 |
| Manning ® 250 | | | | |
| Sep-R-Max ® | | | | |
| | Thickness | 1.87 (mil) | 0.047 (mm) | ASTM D-202A |
| | Tensile: | | | |
| | Machine Direction | 34 (lb/in) | 15.2 (Kg/25 mm) | TAPPI T-494 |
| | Cross machine | unavailable | unavailable | |
| | direction | (lb/in) | (Kg/25 mm) | |
| | Tear (Machine | 20 (g) | 20 (g) | TAPPI T-414 |
| | Direction) | | | |

In summary, the trial production runs illustrated that the directional kraft paper does help create a fault plane for separation of the facing in the machine direction at a selected location. It was also observed that a crease, at least with the papers tested, is preferred to help define the fault plane, so that the paper does not select an undesired path of least resistance during separation. The 37#/2880 ft² directional kraft paper appears to be an acceptable facing layer when creased in the desired location, such as by creasing bars. It is believed that interlocking rollers may be preferred for creating the crease in full production. The 27# facing layer is potentially too thin in its current form for reliable use. It is believed that a directional kraft facing layer between about27-37#/2880 ft², such as 32#/2880 ft² may provide an optimum balance of strength and cost.

FIG. 3 illustrates an exemplary method of adhering facing layer 31 to insulation sheet 10. As illustrated in FIG. 3, sheet 10, which preferably comprise two or more separable longitudinal segments, may be presented by the feed conveyer 104 to a heated roll 102, to which is simultaneously supplied a continuous web of bitumen-coated kraft paper web 31, fed between the heated roll 102 and the sheet 10. The web of kraft paper fed via roller 102 after being bitumen-coated is supplied from a roll 108 on payout stand 118, through an accumulator 138 for tensioning the kraft paper web 31. In addition, the outside surface of the web can be marked at a marking station 114 with identifying information such as the R-value of the glass fiber sheet and the production lot code before the kraft paper web 31 is applied to the bottom of the sheet 10. Optionally, the edges of the kraft paper web 31 are folded over to form the side tabs 18, 19 (FIG. 1) just prior to the web contacting the heated roll 102. The kraft paper web 31 is oriented so that the bitumen-coated side of the kraft paper web 31 faces the bottom of the glass fiber sheet 10 and so that the paper has a higher tensile strength in the conveyed direction of sheet 10 (i.e., along the length of sheet 10) than across the width of sheet 10. The temperature of the heated roll is preferably selected to provide enough heat to soften the bituminous coating, which is supplied from bitumen source 120, such that the bitumen-coated kraft paper web 31 adheres to the underside of the glass fiber sheet 10. The faced glass fiber sheet is transported away from the heated roll 102 by a tractor section 106 and delivered to a chopper 112, which periodically chops the faced glass fiber sheet to form insulation product 100 of appropriate length, e.g., 48-105″ for insulation batts and 32-100′ for insulation rolls.

Prior to or after facing the mat 10 with facing layer 31, the mat 10 may also be provided to a slicer (not shown), which slices the mat into sections or strips having desired widths, e.g., 15″, some of which may be further sectioned to form the separable segments of mat 10 discussed above. The insulation products 100 so formed are then transported to packaging equipment (not shown). If the slicer is disposed prior to application of facing 31, facing layer 31 is provided from separate rolls 108 spaced to provide an individual facing layer 31 of appropriate width to each sliced section of sheet 10.

As described above, mat 10 includes a plurality of separable segments. In one embodiment shown in FIGS. 1 and 1A, mat 10 includes two or more segments that are coupled together along their lengths by an adhesive 20. Commonly assigned U.S. patent application Ser. No. 10/793,496, entitled “Method and Apparatus for Adhering Together Lanes of Compressible Products”, filed Mar. 4, 2004 and U.S. patent application Ser. No. 10/690,295, entitled “Separable Fibrous Insulation”, filed Oct. 21, 2003, the entirety of which are hereby incorporated by reference herein, describe a segmented mat 10 and exemplary methods of making the same. In one embodiment described therein, a wedge device is inserted between two separate lanes of a compressible product, such as an insulation mat, to split apart at least a portion of the lanes of product. Either the wedge device or the separate lanes of the compressible product are advanced to move the wedge device and lanes relative to one another. An adhesive is applied onto an inside wall of one or both of the lanes of the compressible product while at least a portion of the lanes are split. The inside walls of the lanes are then contacted to form a single adhered product, such as mat 10 shown in FIG. 1A including a plurality of separable segments.

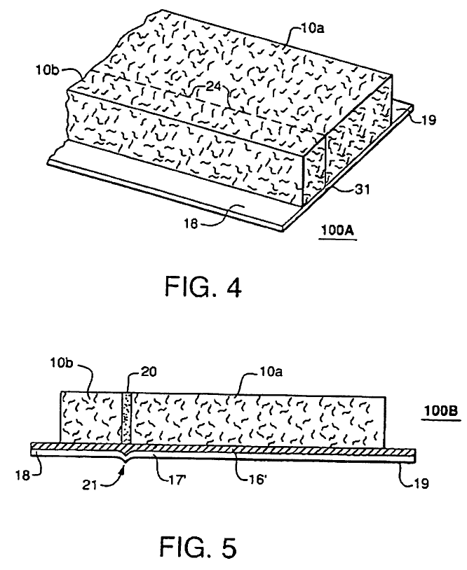

Although FIGS. 1 and 1A illustrate an embodiment of mat 10 formed from two completely separate segments joined by an adhesive, other forms of separable segments are contemplated and may be appropriate. For example, segments 10a and 10b may initially only be partially separated and then reconnected with adhesive 20. Further Weinstein I illustrates in, for example, FIGS. 2-7 thereof a mat having perforated cuts therethrough, leaving separable connectors (formed from the insulation mat) remaining to connect the lengthwise segments of the insulation mat. Weinstein I also discloses a method of forming the perforated mats using water jet cutting or compression cutting stations and rotary cutting saw stations as shown in and described in connection with, for example, FIGS. 16-18 of Weinstein I. Likewise, commonly assigned U.S. patent application Ser. Nos. 10/851,509, filed May 21, 2004, entitled “Segmented Band Joist Batts and Method of Manufacture” and 10/851,877, filed May 21, 2004, entitled “Kit of Parts for Band Joist Insulation and Method of Manufacture”, describe an insulation blanket that is partially or completely divided into separable longitudinal sections by a lengthwise kerf to provide two or more lengthwise segments. FIG. 4 is a perspective view of an insulation product 100A including an insulation blanket having separable segments 10a and 10b coupled together and divided by kerf 24 formed, for example, using a chopping blade or saw.

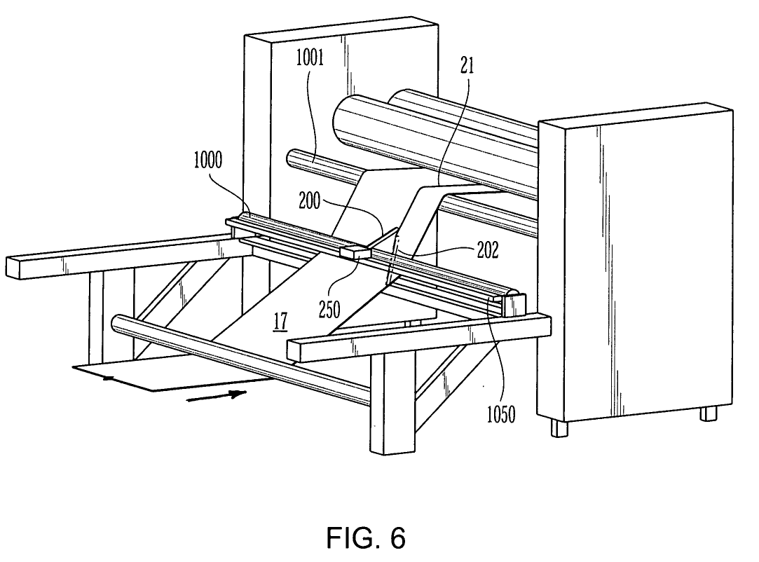

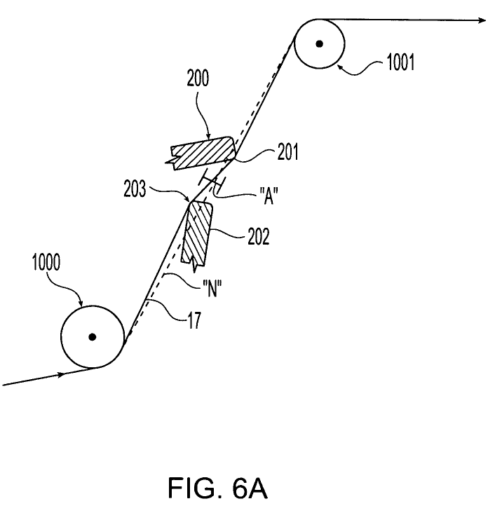

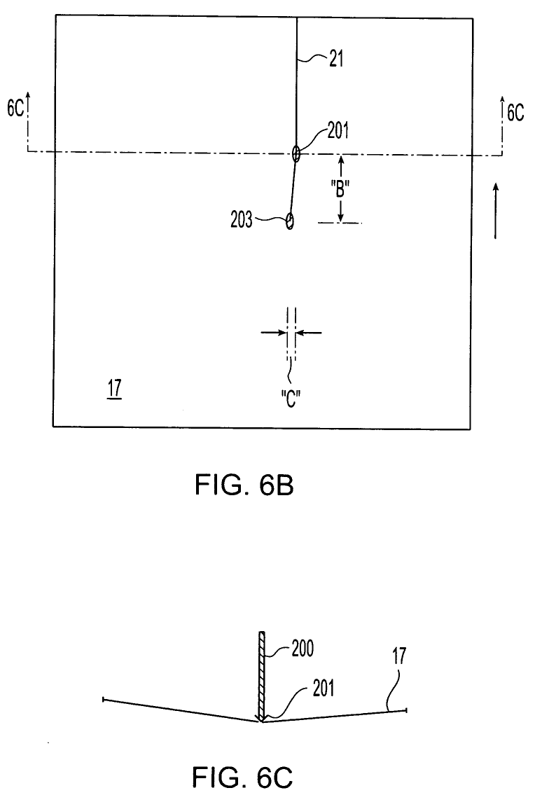

Referring to FIG. 6 through 6C, an exemplary apparatus for imparting a crease 21 in a facing layer 17 is described in greater detail. The apparatus generally comprises a pair of creasing bars 200, 202 which are positioned on opposite sides of the facing layer 17 so as to impinge upon the facing layer as it passes. between first and second rollers 1000, 1001 of the processing machinery. The position of the creasing bars 200, 202 with respect to each other, and with respect to the facing layer 17, controls the physical characteristics of the crease 21. In one embodiment, the crease 21 induced using the creasing bars 200, 202 has a “peaked” shape, as illustrated in FIG. 5. It is noted that although the peak of the FIG. 5 crease 21 points away from the mat 10, the crease peak could also be oriented to point toward the mat 10.

The illustrated apparatus can be used to impart a desired crease 21 in any of a variety of facing layer materials, including, but not limited to, kraft paper, foil scrim kraft (FSK) paper, polymeric (e.g. polypropylene, polyethylene, polystyrene) film, foil, metal foil, laminates thereof, and combinations thereof. Furthermore, depending upon the material chosen, the facing layer can be either water permeable or water impermeable. Additionally, or alternatively, a score line can be used to direct the tearing of the insulation product in a controlled fashion.

It is noted that the illustration of the first and second rollers 1000, 1001 is merely representative in nature, in that they can be located at any desired point along the manufacturing path. Further, one or both of the rollers 1000, 1001 can comprise an accumulator assembly or the like. Referring to the process illustrated in FIG. 3, the creasing bars 200, 202 and rollers 1000, 1001 can be located at any point upstream of the step at which the facing layer 17 is joined to the insulation mat 10. In a preferred embodiment, however, the crease 21 would be applied to the facing layer 17 just before application of the asphalt or bitumen material (where kraft paper facings are used), or before the application of water based adhesives and hot melt adhesives (where foils and film facings are used). Thus, in relation to FIG. 3, the creasing procedure would occur upstream of bitumen source 120.

It is noted that although the creasing procedure could be performed subsequent to the application of the bitumen or other adhesive material to the facing layer 17, however, it is expected that such a procedure would only be practical where the adhesive is cooled or dried, and thus is not “activated.”

An exemplary set of creasing bars 200, 202 can comprise a pair of bar elements each having a creasing surface 201, 203 configured to engage the facing layer 17. The creasing bars 200, 202 can be clamped or otherwise fixed to a portion of the adjoining machinery. In the illustrated embodiment, creasing bar 200 is attached to machine structure 1050 via a connection element 250. Although not shown, creasing bar 202 can be attached to similar structure using a similar connection element. As will be discussed in greater detail later, the connection element 250 (and the connection element associated with creasing bar 202) can be movable along the associated structure (1050 for element 250) to allow the user to adjust the location at which the crease 21 is imparted on the facing layer 17.

The creasing surfaces 201, 203 can be rounded so as to eliminate any sharp corners that could tear the facing layer 17 as it passes between the creasing bars 200, 202. While it will be apparent that alternatively configured creasing surfaces 201, 203 can be used, the rounded configuration can provide a minimum of friction and wear between the bar and the facing layer 17, and is expected to be less likely to cause tearing of the layer at the high manufacturing speeds.

The creasing bars 200, 202 can be oriented at any of a variety of positions with respect to each other, in order to apply the desired crease 21 to the facing layer 17. In the embodiment of FIGS. 6-6C, the upper and lower creasing bars 200, 202 are positioned so that the creasing surface 201 of the upper bar is located a distance “A” below the creasing surface 203 of the lower creasing bar 202. In one embodiment, A is about 0.75 inches. This relative offset causes the portion of the facing layer 17 that contacts the creasing bars 200, 202 to travel between the first and second rollers 1000, 1001 along a gentle “Z”-shaped path substantially perpendicular to the plane “P” of the facing layer. FIG. 6A shows how this “Z”-shaped path deviates from what would be the normal (i.e. unimpinged) path of the facing layer identified as dashed line “N.” The natural tension in the facing layer 17 imparted by the rollers 1000, 1001 and the other system components used to move the facing layer along the manufacturing path causes the facing layer to be drawn over the creasing surfaces 201, 203 with a contact force sufficient to generate the desired crease 21.

In addition to being offset with respect to the plane “P” of the facing layer 17, the creasing bars 200, 202 also can be offset by a dimension “B” (FIG. 6b) in the machine direction, and further by a dimension “C” (FIG. 6b) in the cross-machine direction. The dimension “B” ensures a sufficiently gentle movement of the facing layer 17 along the “Z”-shaped path so as to minimize the chance for layer tearing, while still ensuring that a crease 21 having a desired magnitude is imparted to the facing layer 17. In one embodiment the “B” dimension is about 4.0 inches, while the “C” dimension is about 0.25 inches.

Providing the additional offset between the creasing surfaces 201, 203 in the cross-machine direction can also enhance the magnitude of the crease 21 by forcing the facing layer 17 to travel along a second “Z”-shaped path, defined within the plane “P” of the facing layer 17. Thus, the first bar 200 forces the paper to move slightly in the cross-machine direction, while the second bar 202 forces the paper back in the opposite direction, thus causing the paper to travel along the aforementioned “Z-shaped” path. It is the combination of the two “Z”-shaped paths, one within the plane of the facing layer 17 and the other perpendicular thereto, that creates the desired crease 21.

The described combination of offsets between the creasing surfaces 201, 203 provides a desired crease in the facing layer 17, while simultaneously minimizing or preventing the chance of perforating or tearing the facing layer, and while ensuring that the crease 21 is of sufficient magnitude that it will provide a reliable fault line along which the facing layer can be torn or separated prior to installation on site.

Although the creasing surfaces 201, 203 of creasing bars 200, 202 are shown as being oriented generally perpendicular to the plane of the facing layer (see FIG. 6c), they could be angled with respect to each other.

The described orientation and configuration of the creasing bars 200, 202 is believed to induce a disruption or breakage of the facing fibers, which weakens the facing layer 17 along the line of breakage or disruption sufficiently that a substantially clean tearing or separation of the facing along the crease can be accomplished by the user without the need for tools. This is more than a simple compression of the facing layer 17 at the crease 21. Advantageously, this breakage or disruption is not believed to breach the entire thickness of the facing 21, such as occurs with perforations, but rather simply weakens the facing along the crease line. Thus, a directional tear or separation line is produced which maintains the vapor and waterproof integrity of the facing layer.

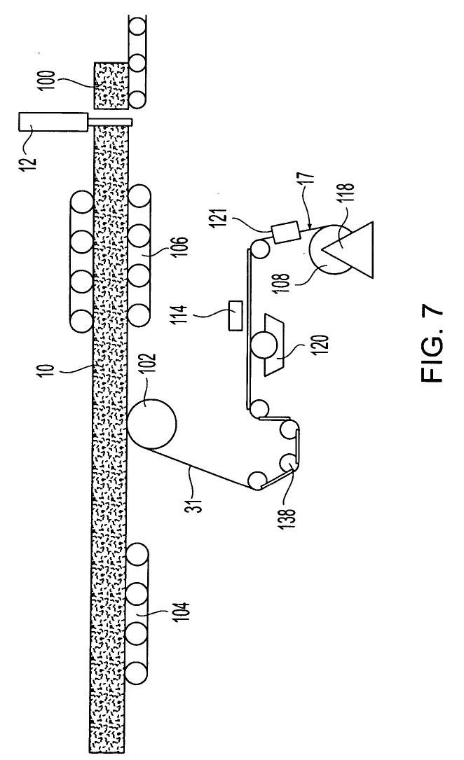

Referring to FIG. 7, a schematic of an exemplary process for providing a creased facing layer 17 is shown. In the illustrated embodiment, the crease 21 is applied to the facing layer 17 at creasing station 121 just prior to the application of surface markings at marking station 114, and before the application of asphalt or other bitumen coating 120. This processing sequence can be important for several reasons, the first being that the absence of bitumen during the creasing process can make it easier to apply a uniform crease to the facing without the reinforcement afforded by the coating. Second, were it applied prior to creasing, the bitumen coating could be transferred to the working surfaces of the creasing mechanism, which could reduce operating efficiency. Third, applying the bitumen coating subsequent to creasing can serve to fill any holes in the facing that may be inadvertently formed during the creasing process.

Once the crease(s) 21, markings and bitumen or other adhesive coating is applied, the creased and coated facing layer 31 is applied to the insulation mat as described in relation to FIG. 3. It will be appreciated that this is but one possible process sequence, and that others can also be used. For example, the roll 108 of facing material can be provided in a pre-creased condition. Likewise, the stations for creasing 121 and marking 114 could be combined into a single station.

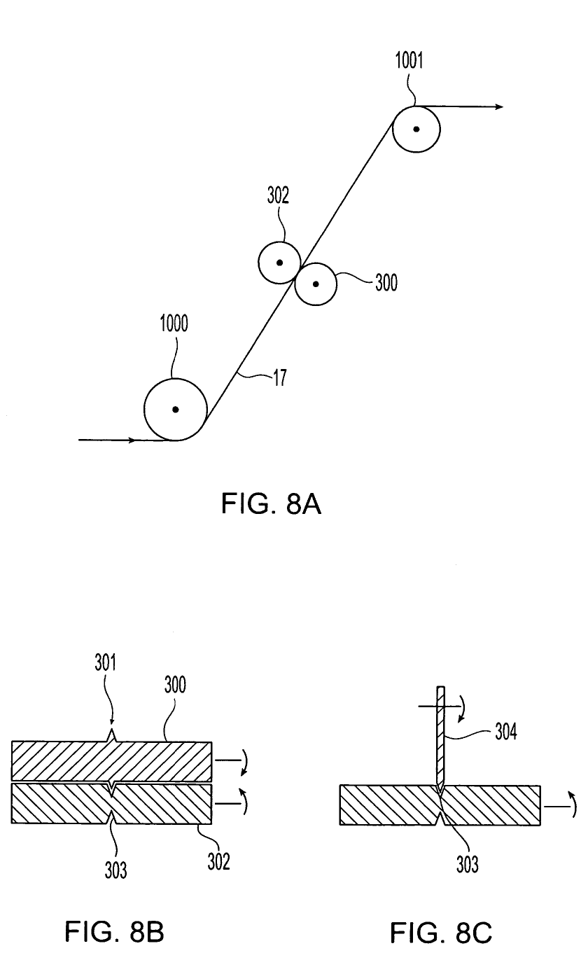

Referring to FIGS. 8a-c, an alternative embodiment of a creasing mechanism is shown, in which first and second interlocking rollers 300, 302 impart the desired crease 21. The rollers 300, 302 are configured with complementary creasing surfaces 301, 303 which can comprise a creasing projection 301 formed in the circumference of the first roller 300 and a creasing recess 303 formed in the circumference of the second roller 302. In the illustrated embodiment, the recess 303 comprises a circumferential “V”-notch, and the creasing projection 301 comprises a circumferential “V”-projection. Thusly configured, when the rollers 300, 302 are placed adjacent to one another and a layer of facing material 17 is threaded therethrough, the movement of the facing layer with respect to the creasing recess 303 and projection 301 causes the desired crease 21 to be formed in the facing layer.

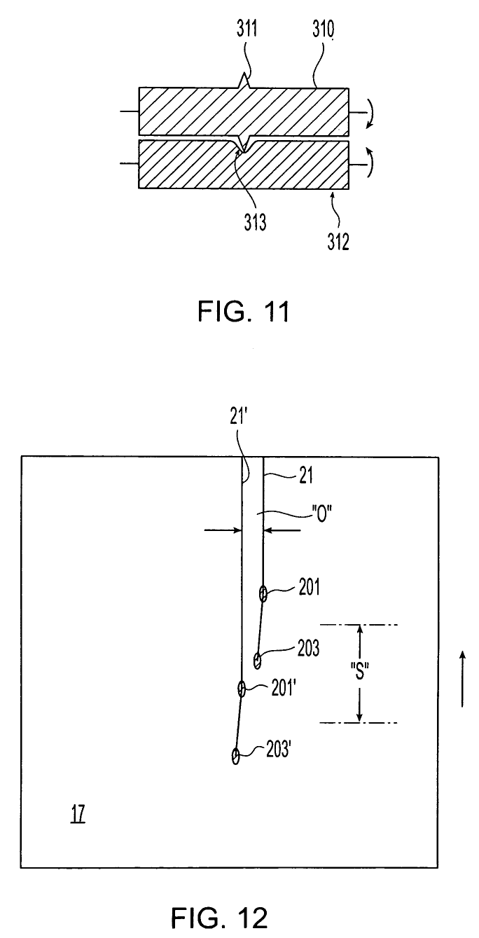

Although “V”-shaped creasing surfaces are disclosed, other shapes can be provided. Examples of such shape profiles are illustrated in FIGS. 10a-c, and can include U-shapes, offset V-shapes, slots, and the like. Alternatively, as shown in FIG. 11, the male roller 310 can engage a flat-surfaced roller 312 without the corresponding notch (303 in FIGS. 8b, c) or a roller with a lower density covering (such as rubber) that would allow the creasing projection 311 to deform the roller at the location of contact 313 with the male roller projection 311. Appropriate deformable materials may be soft urethane or sponge urethane, solid or sponge rubber, cork, open-cell foam, poly-vinyl chloride (PVC) or paraffin. The hardness of the flat-surfaced roller preferably will be less than that of the male roller 310 or at least the creasing projection 301. Further, the deformable material should be resilient so that it will recover subsequent to deformation.

Further, as shown in FIG. 8c, the second roller 302 could be provided with a circumferential “V”-shaped recess 303, while the first roller 300 could be replaced with a thin rotating disc 304 that operates to press the facing material 17 into the recess 303 of the first roller 300 to create the crease 21. As with the previous embodiment, the thin rotating disc 304 could also be used with a flat-surfaced roller 312 of appropriate material. The flat surfaced roller could be made of a hard material, or it could be made of one of the deformable materials previously described.

The benefit of the interlocking roller design (and the alternative rotating disc design) is that the first and second rollers 300, 302 can be rotatable, so that they can rotate with the movement of the facing layer 17, thus substantially reducing friction and associated wear between the creasing surfaces 301, 303 and the facing layer. It would also reduce drag on the facing layer as compared to the static creasing surfaces. The reduction in friction, coupled with the complementary movement of the rollers 300,302 with the facing layer 17, also minimizes the chance that the facing layer could be perforated or torn during the creasing process. This is particularly important when considering the high machine speeds associated with manufacture of facing layers and insulation mats.

A further benefit of the interlocking roller design is that it can be implemented without the need for specific offset positioning between the creasing surfaces as described above in relation to the creasing bars of FIGS. 6A-C. This simplifies the overall design of the production machinery, and also reduces maintenance costs associated with repairing worn parts and/or with repairing or rethreading torn or otherwise damaged facing material that results from interactions with worn creasing surfaces.

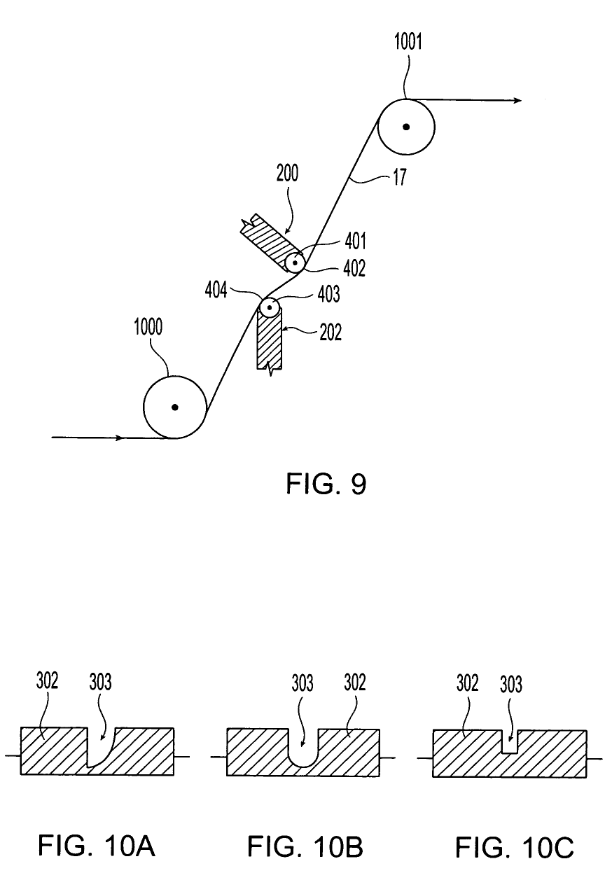

Referring to FIG. 9, the rotating roller or disc concept could be applied to the creasing bars 200, 202, such that a pair of creasing discs 401, 403 could be rotatably mounted to the ends of the creasing bars 200, 202 to provide the desired rounded creasing surfaces 402, 404 while providing the benefits of reduced friction as noted for the interlocking roller design (FIG. 8a). The rotating discs 401, 403 can also be removably mounted to the creasing bars 200, 202 to allow quick and easy replacement when the discs 401, 403 or creasing surfaces 402, 404 become worn with use or if a different creasing surfaces (radius of curvature, end profile, material, etc.) are desired.

Additional alternatives to the described embodiments will be apparent to one of ordinary skill in the art. For example, while the creasing bars 200, 202 can be solid metal with round edges, straight sharp edges can also be used. Further, the rollers 300, 302 and disc 402, 403 embodiments can incorporate bearings to further reduce friction in the assembly. Additionally, simple pieces of wire having rounded or rolled edges could also be used.

The creasing bars 200, 202, rollers 300, 302 and discs 401, 403 can be made of metal (e.g. stainless steel) or they can be made of non-metallic materials. Examples of such non-metallics are polytetrafluorethylene (PTFE) nylon, neoprene, PVC, and the like. One advantage of using metal creasing elements is that they are easily grounded via the feeding machinery to which they connect (the feeding machinery itself being connected to ground). Charge accumulation is expected to be more of an issue with non-metallics, particularly when used to impart creases in film facing materials, and thus, specialized static control methods may be required.

It will be apparent that the described creasing bars 200, 202 interlocking rollers 300, 302 and other described embodiments of creasing surfaces can be adjustable across the width “W” of the facing layer 17 such that a crease 21 can be applied at any desired location along the width of the facing layer. This arrangement allows the manufacturer to make a single run of creased facing layer which can then be used for multiple separable products. That is, a single creased facing layer can have creases that correspond to mats 10 having separable segments 10a, b with different individual widths. Thus, a facing layer 17 could be manufactured with, for example, 2 different machine-direction creases (A, B), which could then be applied to two different runs of insulation mat. For example, the separation plane 22 of separable segments 10a, b of the first run could align with crease A and the separation plane 22 of separable segments 10a, b of the second run could align with crease B. While, for each run, there would be an extra crease in the facing layer not aligning with the separation plane 22, this is not expected to adversely affect the integrity of the insulation product 100.

In one embodiment, multiple sets of creasing devices (200, 202; 300, 302; 400, 402) could be provided for creasing a single facing sheet in multiple locations, and thus several creases could be made simultaneously in a single sheet of facing.

The creasing bars 200, 202 can be mounted to existing process machinery using a connection element 250 comprising clamps, pins or worm screw devices to allow the bars to be moved in relation to the surface of the facing 17. This positional adjustability will allow a single set of bars to be used for various sizes of paper and to induce a crease at various locations along the entire cross-directional width of the facing layer. The adjustability also allows for easy feeding of the facing layer between the creasing bars 200, 202, since the bars can be positioned far apart during the feeding process, and then brought into creasing position only after the facing has been properly fed and adjusted in the process machinery.

An additional benefit to the adjustable creasing mechanism is that it can be used to apply a crease 21 to the facing layer 17 at any point along the layer width “W,” simply by moving the mechanism. This can enable the production of fewer total number of individual rolls of facing that would need to be stored for multiple separated products, since a single roll of facing could be produced with multiple different crease locations and configurations as desired.

Where multiple sets of creasing devices are provided for creasing a single facing sheet in multiple locations, the assemblies can either be located directly adjacent one another (i.e. in the cross-machine direction), or they can be staggered so that adjacent sets are positioned at different locations along the machine direction. An exemplary arrangement is illustrated in FIG. 12, in which adjacent sets of creasing devices (201, 203; 201′, 203′) are staggered by a distance “S” in the machine direction as measured from the centerline of the devices, and are also offset to create a pair of creases 21, 21′ that are offset by a dimension “O.” Such staggering can be advantageous when adjustment mechanisms are provided for controlling the position of the devices, since the staggering can provide additional room for the adjustment mechanisms to fit.

Staggering adjacent creasing devices can provide the additional advantage of allowing multiple creases 21, 21′ to be placed very close together (e.g. offset by as little as 1/16″), even where the adjacent creasing devices (and adjustment mechanisms) themselves would bee too bulky to allow such spacing were the devices placed side-by-side.

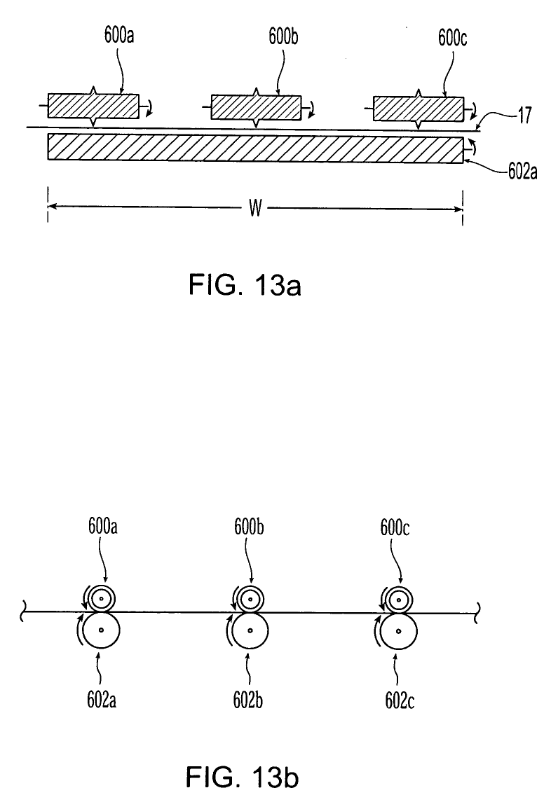

Alternatively, as shown in FIGS. 13a, b, when using roller type creasing surfaces, first rollers 602a can be provided spanning nearly the entire cross-machine width of the facing layer 17, while multiple adjustable smaller second rollers 600a, b, c can be positioned on the opposite side of the facing layer. This would allow the crease location to be adjusted by moving the second rollers 600a-c on a single side of the facing layer, thus simplifying the overall arrangement of the mechanism as well as the adjustment and control process. It will be appreciated that one or more of the second rollers 600 could be replaced by a rotating disc element 304 as previously described in relation to FIG. 8c. Further, the first roller 602 could have multiple creasing recesses (not shown), or it could be made of a deformable material as previously described in relation to FIG. 11. Alternatively, the first roller 602 could actually be provided as two rollers positioned side-by-side or staggered, as desired. The second rollers 600a-c could be manually adjustable along the width of the facing layer 17 or their position could be automatically controlled through the use of a computerized control device.

Also, as shown in en view on FIG. 13b, multiple first rollers 602a-c could be provided, staggered in relation to each other, and one second roller 600a-c could be associated with each of the first rollers. In such cases, the first roller(s) 602a-c may be replaced by a slide bed or supported conveyor belt device, further increasing the possible locations for inducing the creases and improving the efficiency of the assembly.

In a further alternative embodiment, multiple sets of creasing devices can be provided in series to allow a single crease to be performed in more than one step. For example, a first set of creasing surfaces 201, 203 can be positioned to begin the crease 21 and a second set of creasing surfaces 201′, 203′ could be positioned to enhance or complete the crease. This may be an advantage when applying a crease to a metallized base film such as aluminum or other metallized foil facing material. It may also be more effective at applying a crease to the previously described polymeric film facing materials.

It should also be noted that in all of the above descriptions involving multiple creasing elements, such elements can be selectively enabled or disabled as best suits the manufacturing process. These elements may also be mounted in such a way that they can be physically withdrawn from the paper path, for various purposes (such as maintenance), when not in use.

As previously noted, the creasing bars 200, 202 interlocking rollers 300, 302 and other described embodiments of creasing surfaces can be adjustable to allow the position of the individual creasing surfaces 201, 203 with respect to each other, as well as to allow adjustment of adjacent sets of creasing surfaces 201, 203; 201′, 203′ with respect to each other. These individual adjustments can be automated such that movement of each of the elements is remotely controllable, using for example, small servo motors that are remotely or directly controllable. This automation can include computerized control of the individual adjustments, and using the computer may further facilitate precise and accurate repeatable positioning of creases at desired locations on the facing layer 17. Using computerized control can also allow certain “creasing runs” to be pre-programmed for easy repeatable use. Such pre-programming can control the desired spacings between adjacent sets of creasing surfaces 201, 203; 201′, 203′, for a particular creasing run, and can also control the respective offsets of the creasing surfaces 201, 203 in each set to accommodate a particular thickness of facing material passing therebetween. For example, 4-mil kraft paper will behave differently from a fractional mil thickness of film or foil, and thus the offset between opposing creasing surfaces 201, 203 would likely be different for each.

Furthermore, sensors could be installed as part of the individual adjustment mechanisms and/or creasing elements to allow measurement of operational forces on those elements. Such measurements could be used to trip an alarm if a loss in tension or a spike in tension is experienced, each of which could signal a tear or other loss of the facing layer in process. Where computerized controls are used, an alarm could consist of an audible or visual alarm, and could alternatively be set to automatically stop the feeding of facing material through the machine. Also, such measurement devices can be a part of a process control feedback loop, that would allow the creasing elements to be adjusted automatically as necessary to maintain an optimum crease. Such sensors could be measuring and adjusting for position in the cross machine direction, separation distance from other creases or edge of the facing layer, and/or depth of the facing layer or crease being imparted to the facing layer.

In one further embodiment of the device, multiple sets of creasing devices can be provided, some of creasing devices being the bar-type 200, 202 and some others being the roller type 300, 302. Alternatively, some of the creasing devices may have metallic creasing surfaces while others may have non-metallic creasing surfaces. Where computerized controls are used, predetermined sets of creasing devices having desired characteristics could automatically be selected for use with particular facing materials. For example, the control program could operate to automatically designate the use of particular roller type 300, 302 creasing surface sets for creasing a foil facing material, while designating the use of particular bar-type 200, 202 creasing surface sets for creasing kraft paper facing material. In each case, the non-designated sets would be disengaged from the facing material during the particular creasing run.

Further, the described creasing mechanisms of FIGS. 6a-c, 8a-c, 9 and 10a-c can also be used to apply a crease 21 in a facing layer 17 in the cross-machine direction. Such creases could be used as pre-measured separation points to enable the user to cut individual pieces to size (length) without the need for measuring. It is noted that the embodiments that implement rotating creasing surfaces (FIGS. 8a-c, 9 and 10a-c) could be advantageously implemented for this purpose in that they could be adapted to be rolled across the width “W” of the facing layer 17 at designated intervals as the facing layer 17 moves through the production machinery.

In one embodiment, a slidable creasing shuttle (not shown) could be provided for the purpose of imparting a crease in the cross-machine direction. The creasing shuttle could move at an oblique angle with respect to the machine direction, with the angle being selected to move the shuttle one incremental unit in the cross-machine direction for each unit of movement in the machine direction, to produce a movement of the shuttle to move across the width of the facing layer along a substantially straight line. Thus, a crease could be provided in the cross-machine direction without stopping the feeding of the facing material 17 in the machine direction. This cross-machine creasing function could be automated using the previously described computerized control.

Inducing a crease into the paper would provide an easy to identify marking on the product which could represent a predetermined size, thus providing the installer with a guide to where to separate the product. The crease would allow the installer to rip the facing layer along the induced fault plane of the crease, such that tools such as knives may not be necessary for sectioning the facing in the desired location.

The facing layer 17 can also bear markings along the crease line 21 or lines in order to facilitate easy user-visualization of the tearing or separation location on-site. This would enable the installer to quickly identify the separation points for the insulation product, which is a distinct advantage over the directional facing layer having no such markings. In on embodiment, the visual line could be a dashed colored line over the crease. In another embodiment, the visual indication could be a pair of solid or dashed lines that are placed on opposite sides of the crease, indicating that the crease and fault plane lie between the two marks.

The marking fuction also could be performed using the creasing bars or rollers themselves. Thus, the creasing bars 200, 202 could be heated so as to impart a singe or other coloration to the crease 21 in the facing layer 17. Similarly, for embodiments employing creasing bars with creasing discs 401, 403, an ink pad or other ink supply could be provided adjacent to one or both of the discs such that the disc 401, 403 would contact the ink supply just prior to making contact with the facing layer 17, thus depositing ink to the facing layer at or near the crease. Such an inking arrangement could also be used for the interlocking creasing roller 300, 302 embodiment, or for that matter for any embodiment having at least one rotating creasing surface.

Alternatively, an ink jet device or ink marking pad could be positioned on the creasing bars or the roller supports to provide the desired markings.

The creased facing described above can be used with either batt or roll insulation products, including products that are pre-separated (e.g., the separable segments 10a, b of insulation mat 10, illustrated in FIGS. 1, 4 and 5) so that the individual insulation segments can be held together until they need to be used in applications in the field. Further, a crease can be introduced into any desired size and weight facing material. In one preferred embodiment, a 42#/3000 ft² semi-extensible kraft paper can be used, in widths ranging from 15″ to 42″. Again, it will be apparent to one of ordinary skill in the art that a variety of other paper weights can be used with similar effect.

Furthermore, although not preferred, the roller and rotating disc embodiments 300, 302; 402, 403 could be adapted to enable the user to apply perforations in the facing layer rather than a crease or creases. Thus, one or more of the roller or disc elements could be replaced with a perforating wheel or other arrangement suitable for applying a series of perforations to a facing layer (either directional or non-directional facing) in the machine or cross-machine direction, using the apparatus as previously described.

The invention is a device for introducing a crease in the machine direction of the insulation so that a person tearing or cutting the insulation has a crease as an area of weakness in the facing to facilitate the ripping or cutting of the product. This is particularly desirable when the fiberglass or stone wool product adhered to the facing layer has already been cut, perforated or otherwise sectioned such that the separation of the facing layer will allow the insulation product to be separated into one or more pieces, for insulating of variable cavity sections. A substantial advantage of the crease as compared to a perforation of the facing layer or the overlapping and folding of individual adjacent facing sections is that there is no compromise of the vapor retarding properties of the facing, since there are no holes or breaks in the facing. Thus, it guarantees that the vapor barrier of the facing layer remains intact until the products are separated.

This can also be important in the context of product packaging and transport. As previously noted, insulation batts are typically compressed after manufacture and packaged so as to minimize the volume of the product during storage and shipping. Perforations in the facing layer can prematurely pull apart during the compressing step due to substantial forces placed on the sides and ends of the batts. This can cause an undesirable separation of the insulation product and/or facing layer while still in the package (or during subsequent handling). Such premature separation is expected to be substantially reduced or eliminated by using a creased facing layer. This is likely due to the fact that the crease does not penetrate the facing layer, and thus does not create the multiplicity of tear-inducing sites inherent in the perforated facing. The crease is also considered to be generally stronger than the perforations due to the increased cross-section as compared to the perforations.

From the foregoing, a modular faced insulation product is provided that provides for user friendly field separation into smaller segments while not compromising the vapor retarder barrier thereon. In some embodiments, a facing layer having reduced width and/or paper weight but of sufficient cross machine direction tear strength may be achieved. The process of forming a faced insulation product is also simplified in that various facing layers each having different perforation locations are not required for different modular products and need not be stored and/or the step of perforating the facing layer can be eliminated or reduced. Cost saving attributable to materials and storage thereof may be realized.

Although the insulation product has been described as including a facing with its improved machine direction fiber orientation oriented along the length of the insulation product, such that the facing layer and mat can be split into separate longitudinal segments, the facing layer may alternatively be adhered to the insulation mat such that the machine direction of the facing layer aligns with the width of the mat rather than the length of the mat. In this embodiment, the mat of the insulation product may be made separable into mats of varying length rather than width.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

1. An apparatus for imparting a crease in a layer of insulation facing material, comprising first and second facing layer feed elements configured to convey a layer of insulation facing material in a machine direction;
a creasing assembly disposed between the first and second feed elements, the creasing assembly comprising first and second creasing surfaces for receiving a layer of facing material therebetween, the creasing surfaces configured to engage opposite surfaces of the facing material;
wherein when the feed elements operate to convey the facing material in the machine direction, the creasing surfaces are engageable with the opposite surfaces of the facing layer to impart a crease in the facing layer sufficient to allow the layer to be preferentially separated by hand along the crease.

2. The apparatus of claim 1, further comprising an adjustment mechanism to allow the creasing assembly to be selectively adjustable in a cross-machine direction to allow a user to impart a crease at a plurality of locations on the facing layer.

3. The apparatus of claim 2, wherein the adjustment mechanism comprises a worm gear assembly to allow precise control over the adjustment of the creasing assembly.

4. The apparatus of claim 3, further comprising a control system for controlling the adjustment mechanism.

5. The apparatus of claim 4, wherein the adjustment mechanism comprises a control motor, and the control system comprises a computer operable to control the position of the motor.

6. The apparatus of claim 1, wherein the first and second creasing surfaces are selectively adjustable with respect to each other.

7. The apparatus of claim 1, wherein the creasing surfaces are rounded to minimize tearing of the facing layer when the creasing surfaces engage the facing material

8. The apparatus of claim 7, wherein at least one of the creasing surfaces comprises a polymer.

9. The apparatus of claim 8, wherein the polymer is Teflon, nylon or neoprene.

10. The apparatus of claim 9, wherein one of the creasing surfaces is rotatable such that it rotates as the facing layer is moved in the machine direction.

11. The apparatus of claim 10, wherein the first and second creasing surfaces comprise different materials.

12. The apparatus of claim 11, wherein the first creasing surface comprises a resilient material.

13. the apparatus of claim 12, wherein the resilient material is urethane, rubber, cork or neoprene.

14. The apparatus of claim 10, wherein the first and second creasing surfaces have first and second widths, respectively, and wherein the first and second widths are substantially unequal.

15. The apparatus of claim 14, wherein the first and second creasing surfaces are adjustable with respect to each other in a cross-machine direction.

16. The apparatus of claim 10, further comprising an inking element for transferring ink onto the rotatable creasing surface so that when the creasing surface contacts the facing layer, a mark is transferred to the facing layer to facilitate visualization of the crease.

17. The apparatus of claim 10, wherein the first creasing member comprises a circumferential projection and the second creasing member comprises a circumferential recess configured to receive at least a portion of the projection.

18. The apparatus of claim 10, wherein the projection and recess each has a “V” shape in cross-section.

19. The apparatus of claim 10, wherein the first creasing member comprises a circumferential projection and the second creasing member has a substantially flat creasing surface.

20. The apparatus of claim 1, further comprising a heating element for heating at least one of the first and second creasing surfaces to a temperature sufficient to singe the facing layer when the creasing surface contacts the facing layer, the singe providing a marking to facilitate visualization of the crease.

21. The apparatus of claim 1, further comprising a second creasing assembly disposed between the first and second feed elements, the second creasing assembly comprising third and fourth creasing surfaces for receiving the layer of facing material therebetween, the third and fourth creasing surfaces configured to engage opposite surfaces of the facing material; wherein when the feed elements operate to convey the facing material in the machine direction, the third and fourth creasing surfaces are engageable with the opposite surfaces of the facing layer to impart a second crease in the facing layer sufficient to allow the layer to be preferentially separated by hand along the crease; and wherein the second crease in the facing layer is substantially parallel to a crease created by the first and second creasing surfaces.

22. The apparatus of claim 21, wherein the first and second creasing assemblies are adjustable with respect to each other in the machine direction.

23. The apparatus of claim 21, wherein the first and second creasing assemblies are adjustable with respect to each other in a cross-machine direction.

24. The apparatus of claim 21, wherein the fist and second creasing assemblies are positionable so that that the first and second creases are collinear.

25. An apparatus for creasing a layer of insulation facing material comprising:
first and second feed elements configured to convey a layer of insulation facing material in a machine direction and along a first plane;
a facing layer creasing assembly disposed between the first and second feed elements, the creasing assembly comprising first and second opposable creasing elements, each having a creasing surface, the first creasing surface positioned to engage a first surface of the facing layer and the second creasing surface positioned to engage an opposite second surface of the facing layer;
the creasing elements further having a creasing position in which the first creasing surface is located a first distance above the first plane of the facing layer, and the second creasing surface is located a second distance below the first plane layer, so that when the first and second feed elements convey the facing material in the machine direction, a portion of the facing layer travels along a Z-shaped path as it travels between the first and second creasing surfaces;
wherein the contact between the creasing surfaces and the facing layer imparts a crease in the facing layer sufficient to allow the layer to be preferentially separated by hand along the crease.

26. The apparatus of claim 25, further comprising an adjustment mechanism to allow the creasing assembly to be selectively adjustable in a cross-machine direction to allow a user to impart a crease at a plurality of locations on the facing layer.

27. The apparatus of claim 26, further comprising a control system for controlling the adjustment mechanism.

28. The apparatus of claim 27, wherein the adjustment mechanism comprises a control motor, and the control system comprises a computer operable to control the position of the motor.

29. The apparatus of claim 25, wherein the first and second creasing surfaces are selectively adjustable with respect to each other.

30. The apparatus of claim 25, wherein at least one of the creasing surfaces comprises a polymer.

31. The apparatus of claim 30, wherein one of the creasing surfaces is rotatable such that it rotates as the facing layer is moved in the machine direction.

32. The apparatus of claim 31, wherein the first creasing surface comprises urethane, rubber, cork or neoprene.

33. The apparatus of claim 31, wherein the first and second creasing surfaces have first and second widths, respectively, and wherein the first and second widths are substantially unequal.

34. The apparatus of claim 31, wherein the first and second creasing surfaces are adjustable with respect to each other in the cross-machine direction.

35. The apparatus of claim 31, wherein the first creasing member comprises a circumferential projection and the second creasing member comprises a circumferential recess configured to receive at least a portion of the projection.

36. The apparatus of claim 31, wherein the first creasing member comprises a circumferential projection and the second creasing member has a substantially flat creasing surface.

37. The apparatus of claim 25, further comprising a heating element for heating at least one of the first and second creasing surfaces to a temperature sufficient to singe the facing layer when the creasing surface contacts the facing layer, the singe providing a marking to facilitate visualization of the crease.

38. The apparatus of claim 25, further comprising a second creasing assembly disposed between the first and second feed elements, the second creasing assembly comprising third and fourth creasing surfaces for receiving the layer of facing material therebetween, the third and fourth creasing surfaces configured to engage opposite surfaces of the facing material; wherein when the feed elements operate to convey the facing material in the machine direction, the third and fourth creasing surfaces are engageable with the opposite surfaces of the facing layer to impart a second crease in the facing layer sufficient to allow the layer to be preferentially separated by hand along the crease; and wherein the second crease in the facing layer is substantially parallel to a crease created by the first and second creasing surfaces.

39. The apparatus of claim 38, wherein the first and second creasing assemblies are adjustable with respect to each other in the machine direction.

40. The apparatus of claim 38, wherein the first and second creasing assemblies are adjustable with respect to each other in a cross-machine direction.

41. The apparatus of claim 38, wherein the fist and second creasing assemblies are positionable so that that the first and second creases are collinear.

42. A method of manufacturing an insulation product, comprising the following steps:
providing an insulation mat having first and second major surfaces and a pair of side portions;
providing a facing layer;
providing a creasing apparatus having first and second opposing creasing surfaces;
disposing the facing layer between the creasing surfaces; and
moving the facing layer between the creasing surfaces in a machine direction;
wherein the step of moving the facing layer causes the creasing surfaces to impart a fault plane in the facing layer along which the facing layer can be separated by hand.

43. The method of claim 42, wherein the fault plane is imparted substantially in the machine direction.

44. The method of claim 42, wherein the creasing surfaces comprise first and second creasing bars, the creasing surfaces further being rounded to minimize tearing of the facing layer during the moving step.

45. The method of claim 42, wherein the creasing surfaces comprise first and second rotatable elements, wherein during the moving step at least one of the elements rotates with the facing layer.

46. The method of claim 45, wherein the first rotatable element further comprises a circumferential creasing projection, and the second rotatable element comprises a complementary circumferential creasing recess; wherein during the moving step the creasing projection presses a portion of the facing layer into the creasing recess, thereby imparting the fault plane.

47. The method of claim 42, further comprising providing an insulation mat having first and second separable segments, the separable segments associated with each other along a separation plane oriented in the machine direction; and adhering the facing layer to the major surface so that the fault plane is substantially aligned with the separation plane.

48. The method of claim 47, wherein the insulation mat includes a plurality of separable segments, each of said separable segments being coupled to an associated other separable segment along a separation plane oriented in said machine direction, the fault plane being aligned with at least one of the separation planes.

49. The method of claim 42, wherein the fault plane is free of perforations.

50. The method of claim 42, wherein the step of moving the facing layer between the creasing surfaces breaks or disrupts the fibers of the facing layer sufficiently to induce the fault plane.

51. The method of claim 42, wherein the fault plane is imparted in a direction orthogonal to the machine direction.

52. A method of manufacturing an insulation product, comprising:
providing a facing layer;
providing a creasing apparatus having first and second opposing creasing surfaces;
disposing the facing layer between the creasing surfaces; and
moving the facing layer between the creasing surfaces in a machine direction;
wherein the step of moving the facing layer causes the creasing surfaces to impart a crease in the facing layer that allows the facing layer to be preferentially separated along the crease;
providing an insulation mat having first and second separable segments associated with each other along a separation plane;
aligning the facing layer with the insulation mat so that the crease substantially aligns with the separation plane
adhering the facing layer to the insulation mat.

53. The method of claim 52, wherein the aligning and adhering steps are performed substantially simultaneously.

54. The method of claim 53, wherein the creasing apparatus is selectively adjustable in a direction orthogonal to the machine direction; the method further comprising the step of adjusting the creasing apparatus to apply the crease at a selected location on the facing layer.

55. The method of claim 54, wherein the first and second creasing surfaces are adjustable with respect to each other.

56. The method of claim 55, wherein the step of moving the facing layer further comprises marking the facing layer on or near the crease to enhance visualization of the crease by a user.

57. The method of claim 56, wherein the step of providing a creasing apparatus further comprises providing a second creasing apparatus having second and third creasing surfaces, and wherein the step of moving the facing layer causes the creasing surfaces to impart a pair of creases in the facing layer.

58. The method of claim 57, further comprising the step of adjusting a distance between the first and second creasing apparatus to cause the respective creasing surfaces to impart a pair of creases in the facing layer spaced a desired distance apart as measured in the cross-machine direction.

59. The method of claim 58, further comprising the steps of providing a control system for automatically adjusting a distance between the first and second creasing apparatus; and using the control system to adjust the distance between the creasing apparatus.
